(19) United States
(12) Patent Application Publication
(10) Pub. No.: US 2024/0396904 A1
(43) Pub. Date: Nov. 28, 2024

(54) DETECTING EXECUTION OF A WEB SHELL

(71) Applicant: PALO ALTO NETWORKS (ISRAEL ANALYTICS) LTD., Tel Aviv (IL)

(72) Inventor: Gal De Leon, Tel Aviv (IL)

(21) Appl. No.: 18/322,231

(22) Filed: May 23, 2023

(51) Int. Cl. H04L 9/40

(52) U.S. Cl. CPC H04L 63/1416; H04L 63/1466

(57) ABSTRACT

A method includes placing a first hook on a page-executing function configured to execute a web page on a web server, and placing a second hook on at least one sensitive function. The first hook is configured to ascertain whether the page-executing function is called to execute a server-side script, and in response to the page-executing function being called to execute a server-side script, associate, with a current execution thread, data associated with the calling of the page-executing function and indicating that the page-executing function is called to execute the server-side script. The second hook is configured to ascertain whether the sensitive function is called from an execution thread associated with the data, and in response to the sensitive function being called from an execution thread associated with the data, output a message including the data. Other embodiments are also described.

### FIELD OF THE INVENTION

The present invention is related to the field of computer security.

### BACKGROUND OF THE INVENTION

One type of dynamic web page uses a server-side script to vary the content displayed for different users.

A web shell is an interface allowing remote exploitation of a web server. A web-shell attack on a web server involves creating an illegitimate server-side script for a dynamic web page, or illegitimately modifying an existing server-side script, so as to cause the script to function as a web shell, and then executing the web shell so as to exploit the web server.

The hooking of a function refers to the act of modifying the flow of execution when the function is called. For example, in one type of hooking, the function is wrapped in a hook function including additional functionality. Any time the original function is called from outside the hook, execution is redirected to the hook, such that the additional functionality is carried out.

### SUMMARY OF THE INVENTION

There is provided, in accordance with some embodiments of the present invention, a system including a memory and a processor. The memory is configured to store a page-executing function, which is configured to execute a web page on a web server, and one or more sensitive functions. The processor is configured to place a first hook on the page-executing function and a second hook on at least one of the sensitive functions. The first hook is configured to ascertain whether the page-executing function is called to execute a server-side script, and in response to the page-executing function being called to execute a server-side script, associate, with a current execution thread, data associated with the calling of the page-executing function and indicating that the page-executing function is called to execute the server-side script. The second hook is configured to ascertain whether the sensitive function is called from an execution thread associated with the data, and in response to the sensitive function being called from an execution thread associated with the data, output a message including the data.

In some embodiments, the first hook is configured to associate the data with the current execution thread using thread-local storage (TLS).

In some embodiments, the memory is further configured to store a thread-starting function configured to start a new execution thread in response to being called by the current execution thread, and the processor is further configured to place, on the thread-starting function, a third hook configured to:
ascertain whether the current execution thread is associated with the data, and
in response to the current execution thread being associated with the data, associate the data with the new execution thread.

In some embodiments, the memory is further configured to store a queuing function configured add a callback to a queue for assignment to another execution thread in a thread pool in response to being called by the current execution thread, and the processor is further configured to place, on the queuing function, a third hook configured to:
ascertain whether the current execution thread is associated with the data,
in response to the current execution thread being associated with the data, define a wrapper function configured to:
   associate the data with the other execution thread, and
   subsequently to associating the data with the other execution thread, call the callback, and
add the wrapper function to the queue.

In some embodiments, the second hook is configured to output the message to a security service configured to analyze the data so as to compute a likelihood that the page-executing function was called maliciously.

In some embodiments, the message further includes any arguments with which the sensitive function is called.

There is further provided, in accordance with some embodiments of the present invention, a method including placing a first hook on a page-executing function configured to execute a web page on a web server, and placing a second hook on at least one sensitive function. The first hook is configured to ascertain whether the page-executing function is called to execute a server-side script, and in response to the page-executing function being called to execute a server-side script, associate, with a current execution thread, data associated with the calling of the page-executing function and indicating that the page-executing function is called to execute the server-side script. The second hook is configured to ascertain whether the sensitive function is called from an execution thread associated with the data, and in response to the sensitive function being called from an execution thread associated with the data, output a message including the data.

There is provided, in accordance some further with embodiments of the present invention, a computer software product including a tangible non-transitory computer-readable medium in which program instructions are stored. The instructions, when read by a processor, cause the processor to place a first hook on a page-executing function configured to execute a web page on a web server, and to place a second hook on at least one sensitive function. The first hook is configured to ascertain whether the page-executing function is called to execute a server-side script, and in response to the page-executing function being called to execute a server-side script, associate, with a current execution thread, data associated with the calling of the page-executing function and indicating that the page-executing function is called to execute the server-side script. The second hook is configured to ascertain whether the sensitive function is called from an execution thread associated with the data, and in response to the sensitive function being called from an execution thread associated with the data, output a message including the data.

There is provided, further in accordance with some embodiments of the present invention, a system including a memory and a processor. The memory is configured to store a page-executing function, which is configured to execute a web page on a web server, and at least one sensitive function. The processor is configured to ascertain, upon the page-executing function being called, whether the page-executing function is called to execute a server-side script, and in response to the page-executing function being called to execute a server-side script, associate, with a current execution thread, data associated with the calling of the page-executing function and indicating that the page-executing function is called to execute the server-side script. The processor is further configured to ascertain, upon the sensitive function being called, whether the sensitive function is called from an execution thread associated with the data, and in response to the sensitive function being called from an execution thread associated with the data, output a message including the data.

There is further provided, in accordance with some embodiments of the present invention, a method including, upon a page-executing function, which is configured to execute a web page on a web server, being called, ascertaining whether the page-executing function is called to execute a server-side script. The method further includes, in response to the page-executing function being called to execute a server-side script, associating, with a current execution thread, data associated with the calling of the page-executing function and indicating that the page-executing function is called to execute the server-side script. The method further includes, upon a sensitive function being called, ascertaining whether the sensitive function is called from an execution thread associated with the data. The method further includes, in response to the sensitive function being called from an execution thread associated with the data, outputting a message including the data.

The present invention will be more fully understood from the following detailed description of embodiments thereof, taken together with the drawings, in which:

### BRIEF DESCRIPTION OF THE DRAWINGS

FIG. 1 is a schematic illustration of a computer-security system, in accordance with some embodiments of the present invention;

FIGS. 2-5 are flow diagrams for functionality carried out by various function hooks, in accordance with some embodiments of the present invention; and

FIG. 6 is a flow diagram for functionality carried out by a wrapper function, in accordance with some embodiments of the present invention.

### DETAILED DESCRIPTION

### Overview

In general, it may be challenging to detect a web-shell attack while the attack is in progress.

To address this challenge, embodiments of the present invention cleverly utilize at least two strategically-placed hooks, which work together so as to identify instances of a possible web-shell attack.

The first hook is placed on the function that executes a web page in response to a request. The hook checks if the request is for a dynamic execution using a server-side script, and if so, flags the current execution thread by storing parameters of the request in association with the thread.

The second hook is placed on one or more “sensitive functions,” which—based on an assessment by a human expert or by appropriate software—are more likely than other functions to be exploited in a web-shell attack. This hook checks whether the current execution thread, which called the sensitive function, is flagged, indicating that the sensitive function may have been called via execution of a server-side script by the page-executing function. If yes, the hook generates an alert indicating a possible web-shell attack. The alert typically includes the parameters of the request stored by the first hook, and may additionally include any arguments passed to the sensitive function.

In some embodiments, additional hooks are placed on functions that facilitate transferring execution to another execution thread, such as a new thread or a thread in a thread pool. Each of these hooks is configured to check whether the current execution thread is flagged, and if so, to copy the parameters of the request stored by the first hook to the other execution thread to which execution is transferred.

Embodiments of the present invention are applicable to any type of web server configured to deliver dynamic content via a server-side script. The script may be written in any suitable scripting language such as Common Gateway Interface (CGI), Active Server Pages (ASP), Active Server Pages Extended (ASPX), Hypertext Preprocessor (PHP), Java Server Pages (JSP), Node.js, Django, or Ruby on Rails. The script may include statically-compiled code, just-in-time (JIT) compiled code, or interpreted code. Examples of suitable languages for such code include C#, VB.NET, JavaScript, Perl, and Python.

### System Description

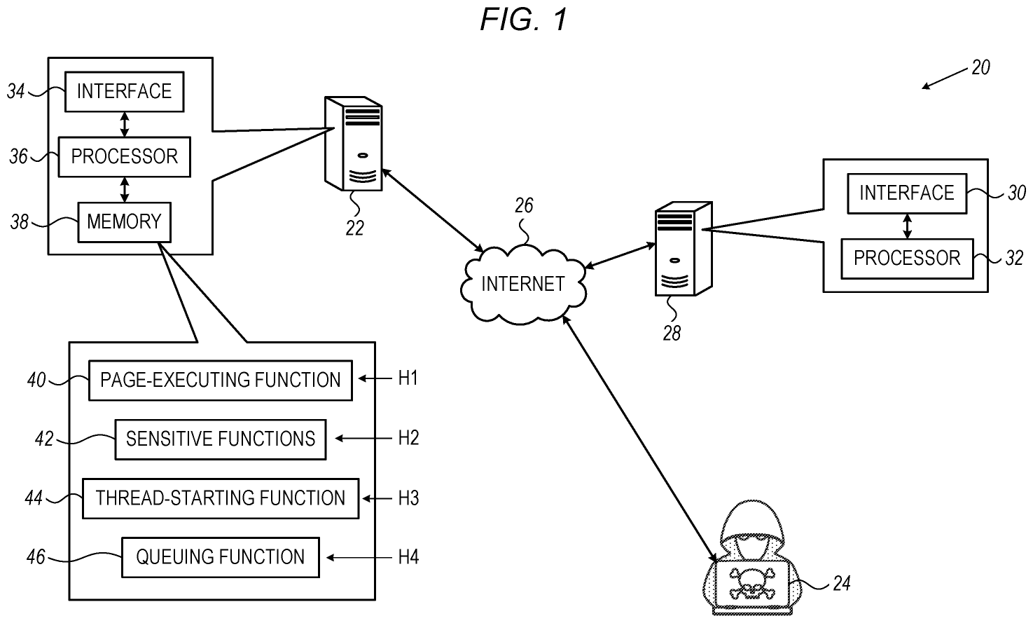

Reference is initially made to FIG. 1, which is a schematic illustration of a computer-security system 20, in accordance with some embodiments of the present invention. As described in detail below, system 20 is configured to detect possible web-shell attacks launched (automatically or manually) using an attacking device 24 over a computer network 26, such as the Internet.

System 20 comprises a web server 22. Web server 22 comprises a network interface 34, comprising a network interface card (NIC) for example, and a processor 36. Web server 22 further comprises a volatile memory 38, comprising a random access memory (RAM) for example, in which program instructions are loaded for execution by processor 36.

Processor 36 is configured to execute a web page in response to requests passed over network 26 and received via network interface 34. Typically, the requests are in accordance with the Hypertext Transfer Protocol (HTTP) or HTTP Secure (HTTPS).

In particular, each request includes a call to a page-executing function 40, which is stored (non-persistently) in memory 38. In response to receiving the request, processor 36 executes page-executing function 40 so as to execute the web page.

Typically, page-executing function 40 calls additional functions stored in memory 38. For example, page-executing function 40 may call (directly or via one or more other functions) one or more sensitive functions 42. Examples of sensitive functions 42 include functions that create a process or object or that evaluate a script, such as the .NET functions Process. Start, ActivexObject.Create, and Eval.JScriptEvaluate. Alternatively or additionally, page-executing function 40 may call (directly or via one or more other functions) a thread-starting function 44, such as the .NET function Thread. Start, which starts a new execution thread (i.e., causes the new execution thread to begin execution) in response to being called by the current execution thread. Alternatively or additionally, page-executing function 40 may call (directly or via one or more other functions) a queuing function 46, such as the C++ function QueueUserWorkItem. In response to being called by the current execution thread, queuing function 46 adds a callback, which is passed as an argument to the queuing function, to a queue for assignment to another execution thread in a thread pool.

In some embodiments, web server 22 is an Internet Information Services (IIS) web server. In such embodiments, processor 36 may run an IIS worker process (w3wp.exe) so as to handle the aforementioned requests, and page-executing function 40 may include the .NET IHttpHandler.ProcessRequest or DefaultHttpHandler.BeginProcessRequest functions, for example.

Optionally, the request may call page-executing function 40 to execute a server-side script, e.g., by passing the name of the file containing the script as an argument to the function. For example, on an IIS web server, the request may specify an Active Server Pages Extended (ASPX) file for execution.

Optionally, processor 36 may be embodied as a cooperatively networked or clustered set of processors. For example, the functionality of web server 22 may be distributed over multiple servers comprising different respective network interfaces and processors.

System 20 further comprises at least one security server 28 comprising a network interface 30, comprising a NIC for example, and a processor 32. Processor 32 is configured to communicate, via network interface 30, with web server 22 over network 26. In particular, processor 32 is configured to provide a security-software download (e.g., in the form of an installation package) to web server 22, the security software being configured to modify pre-existing software on the web server as further described below. Processor 32 is further configured to receive, from the web server, any communication generated by virtue of these modifications.

Processor 32 is further configured to execute a security service, typically cooperatively with processor 36. The security service is configured to identify potential web-shell attacks on web server 22, as further described below with reference to FIG. 3.

Optionally, processor 32 may be embodied as a cooperatively networked or clustered set of processors. For example, the execution of the security service and/or other functionality of security server 28 may be distributed over multiple servers comprising different respective network interfaces and processors.

Typically, the functionality of each of the processors described herein is implemented in software. For example, each of the processors may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Software Modifications

Subsequently to downloading and installing the aforementioned security software, processor 36 executes the security software. The instructions contained in the security software cause processor 36 to place a hook H1 on page-executing function 40 and another hook H2 on at least one of sensitive functions 42. In some embodiments, the instructions also cause processor 36 to place another hook H3 on thread-starting function 44. Alternatively or additionally, the instructions may cause processor 36 to place another hook H4 on queuing function 46.

Typically, the processor hooks (i.e., places a hook on) each of the aforementioned functions by defining a hook function and replacing a pointer to the function with a pointer to the hook function. In particular, for a function written in an interpreted language such as Python, or in a just-in-time (JIT) compiled language such as a .NET JIT compiled language, the new pointer points to the code in which the hook function is written. For a function written in a statically-compiled language such as C++, the new pointer points to the binary instructions that result from compiling the code. By virtue of this pointer replacement, the original function can be called only from within the hook function.

Alternatively, the processor may place an in-line hook on the function, i.e., the processor may change the code or binary instructions of the function.

Typically, the processor hooks the functions in memory 38. In such embodiments, processor 36 may execute the security software, thereby hooking the functions, every time the functions are loaded into memory 38 for execution.

Alternatively, the hooks may be placed in a non-volatile memory (not shown), such as a flash memory, in which the functions are persistently stored.

In some embodiments, reflection is used to locate the functions to be hooked. For example, for web servers based on. NET or Java, the functions may be located using built-in reflection functionality. In other embodiments, such as for web servers based on C++ or Rust (which do not have reflection capabilities), the functions are located by searching the memory for specific instruction sets that are unique to the functions.

Each of the aforementioned hooks is hereby described with reference to the flow diagrams shown in the subsequent figures.

### Page-Executing Function Hook

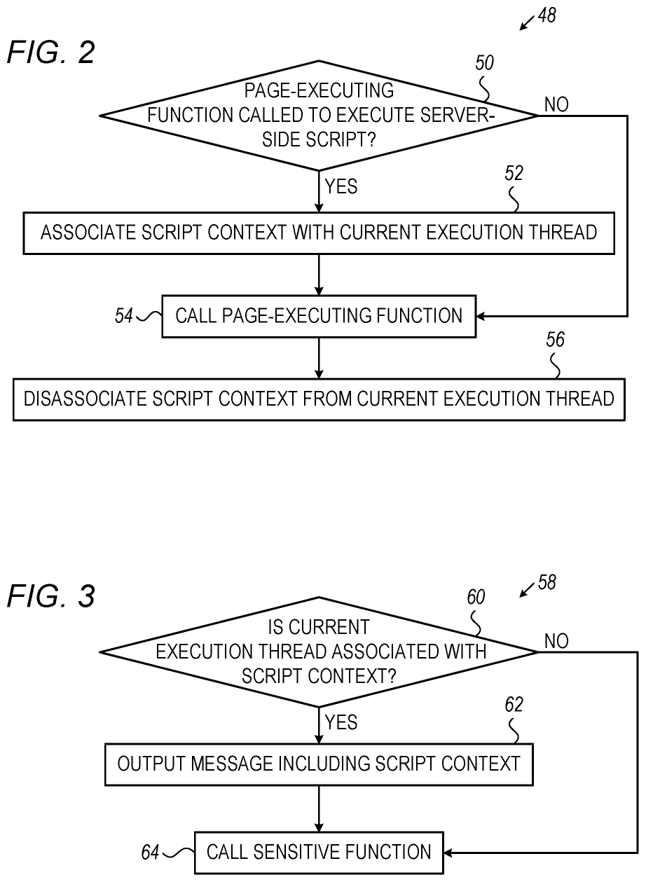

Reference is now made to FIG. 2, which is a flow diagram for functionality 48 carried out by hook H1 (FIG. 1), in accordance with some embodiments of the present invention.

Hook H1 is configured to ascertain, at an ascertaining step 50, whether the page-executing function is called to execute a server-side script, such as an ASPX script. In response to the page-executing function being called to execute a server-side script, the hook carries out an associating step 52, at which the hook associates, with the current execution thread, data associated with the calling of the page-executing function and indicating that the page-executing function is called to execute the server-side script. After associating this data, referred to herein as a “script context,” with the current execution thread, or if the page-executing function was not called to execute a server-side script, the hook calls the page-executing function at a function-calling step 54. (Alternatively, if the hook is in-line, the native functionality of the page-executing function is executed.) Finally, at a disassociating step 56, the hook disassociates the script context (if existent) from the current execution thread, which may be different from the execution thread that was current at associating step 52.

As a purely illustrative example, a hook on the C#IHttpHandler.ProcessRequest function may be defined as follows:

```
void ProcessRequestHook(HttpContext Context) {
  If (EndsWith(Context.URL, “.aspx”)) {
    SetAspxContextForCurrentThread(Context);
  }
  OrigProcessRequest(Context);
  RemoveAspxContextFromCurrentThread( );
}
```

In this example, when a user passes a request, including an HttpContext object as an argument, to web server 22, processor 36 executes the hook ProcessRequestHook instead of the original ProcessRequest function. Upon execution, the hook first checks if the “URL” variable of the argument ends with “.aspx,” indicating that the request specifies an ASPX script for execution. If yes, the hook passes the HttpContext object to another function that sets an ASPX context for the current execution thread, i.e., associates the HttpContext object, or at least some of the data contained therein (including the URL variable), with the current execution thread. Subsequently, the original ProcessRequest function is called with the HttpContext argument. (The function “OrigProcessRequest” references the original ProcessRequest function, as opposed to “ProcessRequest,” which references the hook.) Finally, the hook calls a function that removes the ASPX context from the current execution thread, i.e., disassociates the HttpContext data from the current execution thread.

In some embodiments, hook H1 associates the script context with the current execution thread using thread-local storage (TLS). In other words, the hook stores the script context in a portion of memory 38 (FIG. 1) that is allocated to the current execution thread.

### Sensitive Function Hook

Reference is now made to FIG. 3, which is a flow diagram for functionality 58 carried out by the hook H2 on each hooked sensitive function 42 (FIG. 1), in accordance with some embodiments of the present invention.

Hook H2 is configured to ascertain, at an ascertaining step 60, whether the current execution thread (i.e., the thread from which the sensitive function was called, which may be different from the original thread that began execution of the page-executing function) is associated with a script context. For example, hook H2 may check whether the TLS portion of memory for the current execution thread contains a script context.

If the current execution thread is associated with a script context, hook H2 loads the script context, either while performing ascertaining step 60 (as implied in FIG. 3) or at a separate context-loading step. Subsequently, hook H2 carries out an outputting step 62, at which the hook outputs a message including the script context and, in some embodiments, any arguments with which the sensitive function is called. For example, the hook may output the message to the security service described above with reference to FIG. 1, e.g., by passing the message to an agent installed on web server 22 and configured to execute the security service cooperatively with security server 28, and/or by communicating the message directly to the security server. The security service may then analyze the script context (and, in some embodiments, the arguments with which the sensitive function is called) so as to compute a likelihood that the page-executing function was called maliciously, e.g., during a web-shell attack launched from attacking device 24.

Following outputting step 62, or if the current execution thread is not associated with a script context, hook H2 calls the sensitive function at a function-calling step 64. (Alternatively, if the hook is in-line, the native functionality of function-calling step 64 is executed.)

As a purely illustrative example, a hook on the sensitive .NET Eval.JScriptEvaluate function may be defined as follows:

```
void JScriptEvaluateHook(Params) {
  if (CurrentThreadHasAspxContext( )) {
    var AspxContext = GetAspxContextCurrentThread( );
    ProduceEDREvent(AspxContext, Params);
  }
  OrigJScriptEvaluate(Params);
}
```

In this example, when JScriptEvaluate is called during the processing of the request, the processor executes the hook JScriptEvaluateHook instead of the original JScriptEvaluate function. Upon execution, the hook first checks if the current execution thread has an ASPX context. If yes, the hook loads the ASPX context and then calls the function ProduceEDREvent, which produces an Endpoint Detection and Response (EDR) event by sending an appropriate message to the security service. ProduceEDREvent is called with two arguments: the ASPX context for the current execution thread, and the “Params” argument specified in the call to the sensitive function. Finally, the hook calls the original JScriptEvaluate function with the Params argument.

### Thread-Starting Function Hook

Reference is now made to FIG. 4, which is a flow diagram for functionality 66 carried out by optional hook H3 on thread-starting function 44 (FIG. 1), in accordance with some embodiments of the present invention.

Optional hook H3 on thread-starting function 44 is configured to ascertain, at ascertaining step 60, whether the current execution thread (i.e., the thread from which the thread-starting function was called, which may be different from the original thread that began execution of the page-executing function) is associated with a script context. In response to the current execution thread being associated with a script context, hook H3 associates the script context with the new execution thread started by thread-starting function 44, at an associating step 68. For example, for embodiments in which TLS is used, hook H3 may copy the script context from the portion of memory 38 allocated to the current execution thread to the portion of memory 38 allocated to the new execution thread. Subsequently, or if the current execution thread is not associated with a script context, hook H3 calls the thread-starting function at a function-calling step 70. (Alternatively, if the hook is in-line, the native functionality of the thread-starting function is executed.)

As a purely illustrative example, a hook on the .NET Thread.Start function may be defined as follows:

```
void ThreadStartHook( ) {
  if (CurrentThreadHasAspxContext( )) {
    var AspxContext = GetAspxContextCurrentThread( );
    SetAspxContextForThread(this, AspxContext);
  }
  OrigThreadStart( );
}
```

In this example, when the member function Thread. Start is called for a new execution thread, the processor executes the hook ThreadStartHook instead of the original member function. Upon execution, the hook first checks if the current execution thread (i.e., the execution thread that called Thread. Start) has an ASPX context. If yes, the hook loads the ASPX context and then sets the AspxContext for the new thread. (The variable “this” refers to the new thread.) Subsequently, the hook calls the original member method for the new thread.

Alternatively to the function that starts the new execution thread, hook H3 may be placed on the function that creates the new execution thread, such as the C++ function CreateThread.

### Queuing Function Hook

Reference is now made to FIG. 5, which is a flow diagram for functionality 76 carried out by optional hook H4 on queuing function 46 (FIG. 1), in accordance with some embodiments of the present invention.

As described above, queuing function 46 is configured to add a callback, which is passed as an argument to the queuing function, to a queue for assignment to another execution thread in a thread pool. Hook H4 is configured to ascertain, at ascertaining step 60, whether the current execution thread (i.e., the thread from which the queuing function was called, which may be different from the original thread that began execution of the page-executing function) is associated with a script context. In response to the current execution thread being associated with a script context, hook H4, at a wrapper-defining step 78, defines a wrapper function that wraps the callback, as described immediately below. Finally, hook H4 adds the wrapper function to the queue at a queuing step 80. Alternatively, if the current execution thread is not associated with a script context, hook H4 adds the callback to the queue at an alternative queuing step 82.

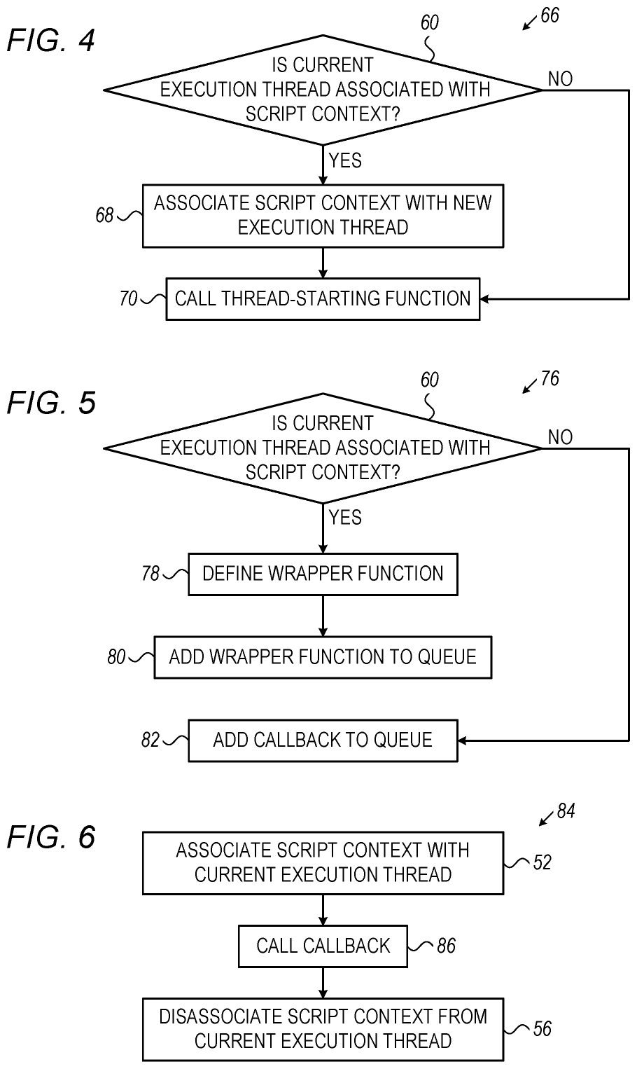

Reference is now made to FIG. 6, which is a flow diagram for functionality 84 carried out by the wrapper function, in accordance with some embodiments of the present invention.

The wrapper function, which may also be viewed as a dynamic hook on the callback, is configured to carry out associating step 52 so as to associate the script context with whichever execution thread the wrapper function is assigned to. For example, for embodiments using TLS, the wrapper function may copy the script context as described above for hook H3. Subsequently to performing this association, the wrapper function calls the callback at a callback-calling step 86. Finally, the wrapper function carries out disassociating step 56.

As a purely illustrative example, the following pseudocode defines a hook on a function “QueueWorkItem,” which assigns a callback workItem to a thread pool queue:

```
QueueWorkItemHook(workItem) {
  if (CurrentThreadHasAspxContext( )) {
    var AspxContext = GetAspxContextCurrentThread( );
    newWorkItem = new lambda( ) {
      SetAspxContextForCurrentThread(AspxContext);
      OrigWorkItem( );
      RemoveAspxContextFromCurrentThread( );
    }
    workItem = newWorkItem;
  }
  QueueWorkItem(workItem);
}
```

In this example, when QueueWorkItem is called to queue the callback workItem during the processing of the request, the processor executes the hook QueueWorkItemHook instead of the original QueueWorkItem function. Upon execution, the hook first checks if the current execution thread has an ASPX context. If yes, the hook defines a wrapper function newWorkItem, which wraps the original workItem function as described immediately below. Subsequently, the hook assigns newWorkItem to the variable workItem. Finally, the hook calls the original QueueWorkItem function with the variable workItem as an argument.

Following the assignment of the wrapper function to an execution thread from the pool, the wrapper function is executed. Upon execution, the wrapper function first sets the ASPX context for the execution thread, e.g., by copying the ASPX context to the appropriate TLS portion of memory. Next, the wrapper function calls the original workItem function. Finally, the wrapper function removes the ASPX context from the thread.

Thus, advantageously, hooks H3 and H4 facilitate the identification, by hook H2, of a malicious calling of a sensitive function, even if the sensitive function is called from a thread different from the original thread that began execution of the page-executing function.

It is noted that the flow diagrams shown in FIGS. 2-6 are provided by way of example only, and that the scope of the present invention includes any suitable modification to these flows, including the addition, modification, or omission of one or more steps.

It will be appreciated by persons skilled in the art that the present invention is not limited to what has been particularly shown and described hereinabove. Rather, the scope of embodiments of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a memory, configured to store a page-executing function, which is configured to execute a web page on a web server, and one or more sensitive functions; and
a processor, configured to:
place, on the page-executing function, a first hook configured to:
ascertain whether the page-executing function is called to execute a server-side script, and
in response to the page-executing function being called to execute a server-side script, associate, with a current execution thread, data associated with the calling of the page-executing function and indicating that the page-executing function is called to execute the server-side script, and
place, on at least one of the sensitive functions, a second hook configured to:
ascertain whether the sensitive function is called from an execution thread associated with the data, and
in response to the sensitive function being called from an execution thread associated with the data,
output a message including the data.

2. The system according to claim 1, wherein the first hook is configured to associate the data with the current execution thread using thread-local storage (TLS).

3. The system according to claim 1, wherein the memory is further configured to store a thread-starting function configured to start a new execution thread in response to being called by the current execution thread, and wherein the processor is further configured to place, on the thread-starting function, a third hook configured to:
ascertain whether the current execution thread is associated with the data, and
in response to the current execution thread being associated with the data, associate the data with the new execution thread.

4. The system according to claim 1, wherein the memory is further configured to store a queuing function configured add a callback to a queue for assignment to another execution thread in a thread pool in response to being called by the current execution thread, and wherein the processor is further configured to place, on the queuing function, a third hook configured to:
ascertain whether the current execution thread is associated with the data,
in response to the current execution thread being associated with the data, define a wrapper function configured to:
associate the data with the other execution thread, and
subsequently to associating the data with the other execution thread, call the callback, and
add the wrapper function to the queue.

5. The system according to claim 1, wherein the second hook is configured to output the message to a security service configured to analyze the data so as to compute a likelihood that the page-executing function was called maliciously.

6. The system according to claim 1, wherein the message further includes any arguments with which the sensitive function is called.

7. A method, comprising:
placing a first hook on a page-executing function configured to execute a web page on a web server, the first hook being configured to:
ascertain whether the page-executing function is called to execute a server-side script, and
in response to the page-executing function being called to execute a server-side script, associate, with a current execution thread, data associated with the calling of the page-executing function and indicating that the page-executing function is called to execute the server-side script; and
placing a second hook on at least one sensitive function, the second hook being configured to:
ascertain whether the sensitive function is called from an execution thread associated with the data, and
in response to the sensitive function being called from an execution thread associated with the data, output a message including the data.

8. The method according to claim 7, wherein the first hook is configured to associate the data with the current execution thread using thread-local storage (TLS).

9. The method according to claim 7, further comprising placing a third hook on a thread-starting function configured to start a new execution thread in response to being called by the current execution thread, the third hook being configured to:
ascertain whether the current execution thread is associated with the data, and
in response to the current execution thread being associated with the data, associate the data with the new execution thread.

10. The method according to claim 7, further comprising placing a third hook on a queuing function configured to add a callback to a queue for assignment to another execution thread in a thread pool in response to being called by the current execution thread, the third hook being configured to:
ascertain whether the current execution thread is associated with the data,
in response to the current execution thread being associated with the data, define a wrapper function configured to:
associate the data with the other execution thread, and
subsequently to associating the data with the other execution thread, call the callback, and
add the wrapper function to the queue.

11. The method according to claim 7, wherein the second hook is configured to output the message to a security service configured to analyze the data so as to compute a likelihood that the page-executing function was called maliciously.

12. The method according to claim 7, wherein the message further includes any arguments with which the sensitive function is called.

13. A computer software product comprising a tangible non-transitory computer-readable medium in which program instructions are stored, which instructions, when read by a processor, cause the processor to:
place a first hook on a page-executing function configured to execute a web page on a web server, the first hook being configured to:
ascertain whether the page-executing function is called to execute a server-side script, and
in response to the page-executing function being called to execute a server-side script, associate, with a current execution thread, data associated with the calling of the page-executing function and indicating that the page-executing function is called to execute the server-side script, and
place a second hook on at least one sensitive function, the second hook being configured to:
ascertain whether the sensitive function is called from an execution thread associated with the data, and
in response to the sensitive function being called from an execution thread associated with the data, output a message including the data.

14. The computer software product according to claim 13, wherein the first hook is configured to associate the data with the current execution thread using thread-local storage (TLS).

15. The computer software product according to claim 13, wherein the instructions further cause the processor to place a third hook on a thread-starting function configured to start a new execution thread in response to being called by the current execution thread, the third hook being configured to:
ascertain whether the current execution thread is associated with the data, and
in response to the current execution thread being associated with the data, associate the data with the new execution thread.

16. The computer software product according to claim 13, wherein the instructions further cause the processor to place a third hook on a queuing function configured to add a callback to a queue for assignment to another execution thread in a thread pool in response to being called by the current execution thread, the third hook being configured to:
ascertain whether the current execution thread is associated with the data,
in response to the current execution thread being associated with the data, define a wrapper function configured to:
associate the data with the other execution thread, and
subsequently to associating the data with the other execution thread, call the callback, and
add the wrapper function to the queue.

17. The computer software product according to claim 13, wherein the second hook is configured to output the message to a security service configured to analyze the data so as to compute a likelihood that the page-executing function was called maliciously.

18. The computer software product according to claim 13, wherein the message further includes any arguments with which the sensitive function is called.

19. A system, comprising:
a memory, configured to store a page-executing function, which is configured to execute a web page on a web server, and at least one sensitive function; and
a processor, configured to:
ascertain, upon the page-executing function being called, whether the page-executing function is called to execute a server-side script,
in response to the page-executing function being called to execute a server-side script, associate, with a current execution thread, data associated with the calling of the page-executing function and indicating that the page-executing function is called to execute the server-side script,
ascertain, upon the sensitive function being called, whether the sensitive function is called from an execution thread associated with the data, and
in response to the sensitive function being called from an execution thread associated with the data, output a message including the data.

20. The system according to claim 19, wherein the processor is configured to associate the data with the current execution thread using thread-local storage (TLS).

21. The system according to claim 19, wherein the memory is further configured to store a thread-starting function configured to start a new execution thread in response to being called by the current execution thread, and wherein the processor is further configured to:
ascertain, upon the thread-starting function being called, whether the current execution thread is associated with the data, and
in response to the current execution thread being associated with the data, associate the data with the new execution thread.

22. The system according to claim 19, wherein the memory is further configured to store a queuing function configured add a callback to a queue for assignment to another execution thread in a thread pool in response to being called by the current execution thread, and wherein the processor is further configured to:
ascertain, upon the queuing function being called, whether the current execution thread is associated with the data,
in response to the current execution thread being associated with the data, define a wrapper function configured to:
associate the data with the other execution thread, and
subsequently to associating the data with the other execution thread, call the callback, and
add the wrapper function to the queue.

23. The system according to claim 19, wherein the processor is configured to output the message to a security service configured to analyze the data so as to compute a likelihood that the page-executing function was called maliciously.

24. The system according to claim 19, wherein the message further includes any arguments with which the sensitive function is called.

25. A method, comprising:
upon a page-executing function, which is configured to execute a web page on a web server, being called, ascertaining whether the page-executing function is called to execute a server-side script;
in response to the page-executing function being called to execute a server-side script, associating, with a current execution thread, data associated with the calling of the page-executing function and indicating that the page-executing function is called to execute the server-side script;
upon a sensitive function being called, ascertaining whether the sensitive function is called from an execution thread associated with the data; and
in response to the sensitive function being called from an execution thread associated with the data, outputting a message including the data.

26. The method according to claim 25, wherein associating the data with the current execution thread comprises associating the data with the current execution thread using thread-local storage (TLS).

27. The method according to claim 25, further comprising:
upon a thread-starting function, which is configured to start a new execution thread in response to being called by the current execution thread, being called, ascertaining whether the current execution thread is associated with the data; and
in response to the current execution thread being associated with the data, associating the data with the new execution thread.

28. The method according to claim 25, further comprising:
upon a queuing function, which is configured to add a callback to a queue for assignment to another execution thread in a thread pool in response to being called by the current execution thread, being called, ascertaining whether the current execution thread is associated with the data;
in response to the current execution thread being associated with the data, defining a wrapper function configured to:
associate the data with the other execution thread, and
subsequently to associating the data with the other execution thread, call the callback; and
adding the wrapper function to the queue.

29. The method according to claim 25, wherein outputting the message comprises outputting the message to a security service configured to analyze the data so as to compute a likelihood that the page-executing function was called maliciously.

30. The method according to claim 25, wherein the message further includes any arguments with which the sensitive function is called.
